(19) United States
(12) Patent Application Publication
(10) Pub. No.: US 2010/0054526 A1
(43) Pub. Date: Mar. 4, 2010

(54) METHOD, APPARATUS AND COMPUTER PROGRAM PRODUCT FOR PROVIDING GAZE INFORMATION

(76) Inventor: Dean Eckles, Palo Alto, CA (US)

Correspondence Address: DITTHAVONG MORI & STEINER, P.C., 918 Prince Street, Alexandria, VA, 22314, US

(21) Appl. No.: 12/203,576

(22) Filed: Sep. 3, 2008

(51) Int. Cl. G06K 9/00

(52) U.S. Cl. 382/100

(57) ABSTRACT

An apparatus for providing gaze information may include a processor. The processor may be configured to receive content, determine gaze information of an individual relative to the content, modify the gaze information based on modification criteria, modify the content based on the modified gaze information, and provide for visualization of the modified content. A corresponding method and computer program product are also provided.

### TECHNOLOGICAL FIELD

Embodiments of the present invention relate generally to communications technology and, more particularly, relate to apparatuses, methods and computer program products for enabling the provision of gaze information to a participant in a communication session.

### BACKGROUND

Communication devices are becoming increasingly ubiquitous in the modern world. In particular, mobile communication devices seem to be particularly popular with people of all ages, socio-economic backgrounds and sophistication levels. Accordingly, users of such devices are becoming increasingly attached to their respective mobile communication devices. Whether such devices are used for calling, emailing, sharing or consuming media content, gaming, navigation or various other activities, people are more connected to their devices and consequently more connected to each other and to the world at large.

Due to advances in processing power, memory management, application development, power management and other areas, communication devices, such as computers, mobile telephones, cameras, personal digital assistants (PDAs), media players and many others are becoming more capable. Furthermore, many such devices are becoming capable of performing tasks associated with more than one of the above listed devices and other tasks as well. Numerous networks and communication protocols have also been developed to support communication between these devices. As a result, whether for business, entertainment, daily routine or other pursuits, communication devices are becoming increasingly reliable and capable mechanisms for sharing information.

With the rise in popularity of communication devices, communication is no longer limited to face-to-face communication and text or speech based communication. Instead, computer-mediated communication (CMC) is becoming more common. CMC may provide the ability for aspects of any or all of face-to-face communication and text or speech based communication to be realized.

### BRIEF SUMMARY OF EXAMPLE EMBODIMENTS

A method, apparatus and computer program product are therefore provided that may enable the provision of gaze information, for example, in the context of CMC. Thus, for example, a user may be enabled to receive information regarding where either the user's own or another user's gaze is directed. Embodiments of the present invention may further enable modification of gaze information and/or synthesis of the gaze information based on various different factors thereby enhancing raw gaze information. Embodiments may also provide for visualization of the modified and/or synthesized gaze information for a participant in a communication session.

In one example embodiment, a method of providing gaze information is provided. The method may include receiving content, determining gaze information of an individual relative to the content, modifying the gaze information based on modification criteria, modifying the content based on the modified gaze information, and providing for visualization of the modified content.

In another example embodiment, a computer program product for providing gaze information is provided. The computer program product may include at least one computer-readable storage medium having computer-executable program code portions stored therein. The computer-executable program code portions may include first program code instructions, second program code instructions, third program code instructions, fourth program code instructions and fifth program code instructions. The first program code instructions may be for receiving content. The second program code instructions may be for determining gaze information of an individual relative to the content. The third program code instructions may be for modifying the gaze information based on modification criteria. The fourth program code instructions may be for modifying the content based on the modified gaze information. The fifth program code instructions may be for providing for visualization of the modified content.

In another example embodiment, an apparatus for providing gaze information is provided. The apparatus may include a processor that may be configured to receive content, determine gaze information of an individual relative to the content, modify the gaze information based on modification criteria, modify the content based on the modified gaze information, and provide for visualization of the modified content.

In yet another example embodiment an apparatus for providing gaze information is provided. The apparatus may include means for receiving content, means for determining gaze information of an individual relative to the content, means for modifying the gaze information based on modification criteria, means for modifying the content based on the modified gaze information, and means for providing for visualization of the modified content.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system according to an example embodiment of the present invention;

FIG. 2 is a schematic block diagram of an apparatus for providing gaze information according to an example embodiment of the present invention;

FIG. 3 illustrates a control flow diagram of a situation in which a service platform may be employed for the modification of gaze information according to an example embodiment of the present invention;

FIG. 4 illustrates a control flow diagram of alternative situations in which a service platform may be employed for the modification of gaze information according to an example embodiment of the present invention;

FIG. 5 illustrates a control flow diagram of a situation in which the modification of gaze information may be accomplished without assistance from a service platform according to an example embodiment of the present invention; and

FIG. 6 is a flowchart according to an example method of providing gaze information according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “content item,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

CMC may change communication in three general ways. For example, CMC may remove or distort gaze information, may collapse perspective or create a new reference context, and may allow for transformation and/or synthesis of gaze information. As such, active transformation of gaze information may be utilized to influence how communication is conducted for the benefit of one, some or all of the participants. Embodiments of the present invention may enable active transformations of gaze information based on various different criteria and may also enable visualization of transformed (or modified) gaze information based on certain criteria. Accordingly, communication such as CMC may be enhanced.

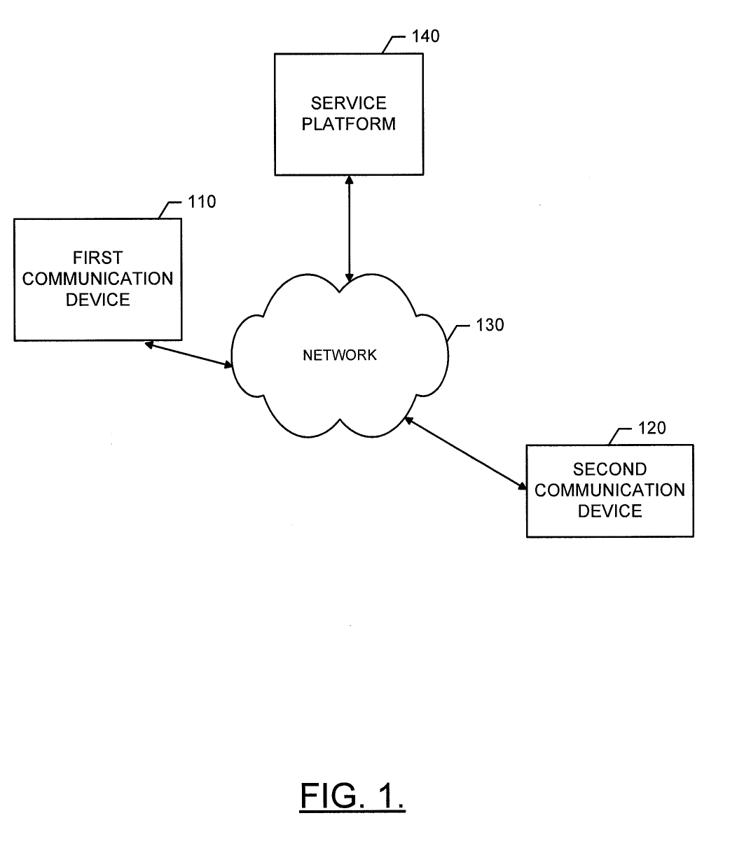

Referring now to FIG. 1, an embodiment of a system in accordance with an example embodiment of the present invention is illustrated. The system of FIG. 1 may include a first communication device 110 and a second communication device 120 in communication with each other via a network 130. In some cases, embodiments of the present invention may further include a network device such as a service platform 140; however, the service platform 140 may not be included in certain instances.

The network 130 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 130. Although not necessary, in some embodiments, the network 130 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the first and second communication devices 110 and 120 may be in communication with each other via the network 130 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the first and second communication devices 110 and 120 via the network 130. By directly or indirectly connecting the first and second communication devices 110 and 120 and other devices to the network 130, the first and second communication devices 110 and 120 may be enabled to communicate with the other devices or each other, for example, according to numerous communication protocols including Hypertext Transfer Protocol (HTTP) and/or the like, to thereby carry out various communication or other functions of the first and second communication devices 110 and 120, respectively.

Furthermore, although not shown in FIG. 1, the first and second communication devices 110 and 120 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the first and second communication devices 110 and 120 may be enabled to communicate with the network 130 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, either of the first communication device 110 and the second communication device 120 may be mobile or fixed communication devices. Thus, for example, the first and second communication devices 110 and 120 could be any of personal computers (PCs), PDAs, wireless telephones, desktop computer, laptop computers, mobile computers, cameras, video recorders, audio/video players, positioning devices, game devices, television devices, radio devices, or various other like devices or combinations thereof.

In an example embodiment, the service platform 140 may be a device or node such as a server or other processing element. The service platform 140 may have any number of functions or associations with various services. As such, for example, the service platform 140 may be a platform such as a dedicated server (or server bank) associated with CMC functionality, or the service platform 140 may be a backend server associated with one or more other functions or services having additional capability for supporting CMC as described herein. The functionality of the service platform 140 may be provided by hardware and/or software components configured to operate in accordance with embodiments of the present invention.

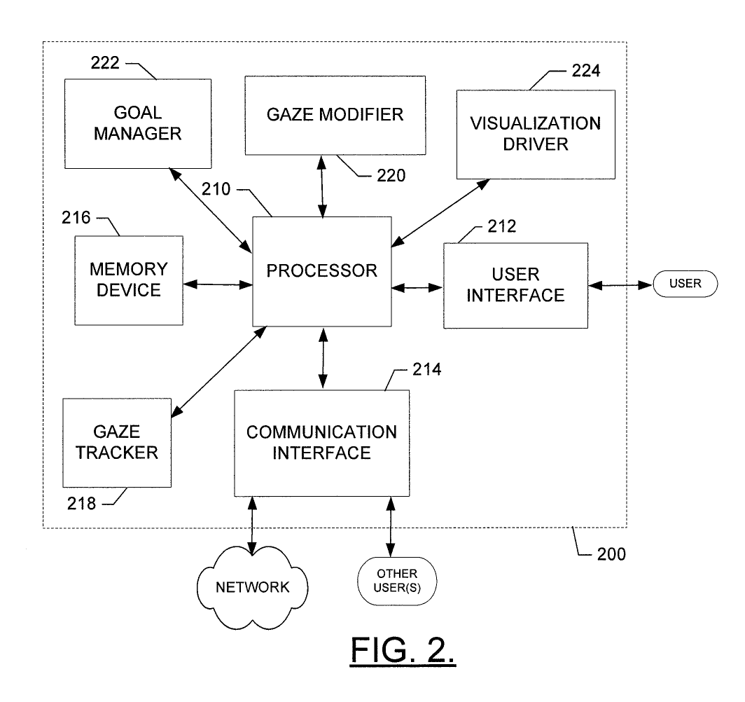

In an example embodiment, gaze information may be collected at one or both of the first and second communication devices 110 and 120. The gaze information may be modified based on certain criteria either at the device at which the gaze information is collected or at the device to which the gaze information is communicated (e.g., the service platform 140 or the other device). The modified gaze information may then be visualized at either the device at which the gaze information is collected or the other device. In some cases, the gaze information may be determined from or associated with video content and the visualization of the modified gaze information may include playing the video content after the video content has been modified according to the modified gaze information. Examples of apparatuses that could be included in or embodied as either one of the first and second communication devices or the service platform 140 and configured in accordance with embodiments of the present invention will be explained below in reference to FIG. 2.

An example embodiment of the invention will now be described with reference to FIG. 2, in which certain elements of an apparatus 200 for providing gaze information are displayed. The apparatus 200 of FIG. 2 may be employed, for example, on the first communication device 110, the second communication device 120 and/or the server platform 140. However, it should be understood that it is not necessary for both communication devices to include all or even some of the elements described herein (although in a symmetrical embodiment both may include elements of the apparatus 200). Furthermore, it should be noted that the apparatus 200 of FIG. 2, may also be employed on a variety of other devices, both mobile and fixed, and therefore, embodiments of the present invention should not be limited to application on devices such as those listed above. Alternatively, embodiments may be employed on a combination of devices including, for example, those listed above. Moreover, embodiments of the present invention may be embodied wholly at a single device or by a combination of devices such as when devices are in a client/server relationship. Furthermore, it should be noted that the devices or elements described below may not be mandatory and thus some may be omitted in certain embodiments.

Referring now to FIG. 2, an apparatus 200 for providing gaze information is provided. The apparatus 200 may include or otherwise be in communication with a processor 210, a user interface 212, a communication interface 214 and a memory device 216. The memory device 216 may include, for example, volatile and/or non-volatile memory. The memory device 216 may be configured to store information, data, applications, instructions and/or the like for enabling the apparatus to carry out various functions in accordance with example embodiments of the present invention. For example, the memory device 216 could be configured to buffer input data for processing by the processor 210. Additionally or alternatively, the memory device 216 could be configured to store instructions for execution by the processor 210. As yet another alternative, the memory device 216 may be one of a plurality of databases that store information and/or media content.

The processor 210 may be embodied in a number of different ways. For example, the processor 210 may be embodied as various processing means such as a processing element, a coprocessor, a controller or various other processing devices including integrated circuits such as, for example, an ASIC (application specific integrated circuit), an FPGA (field programmable gate array), a hardware accelerator, and/or the like. In an example embodiment, the processor 210 may be configured to execute instructions stored in the memory device 216 or otherwise accessible to the processor 210.

Meanwhile, the communication interface 214 may be embodied as any device or means embodied in either hardware, software, or a combination of hardware and software that is configured to receive and/or transmit data from/to a network and/or any other device or module in communication with the apparatus 200. In this regard, the communication interface 214 may include, for example, an antenna and supporting hardware and/or software for enabling communications with a wireless communication network. In fixed environments, the communication interface 214 may alternatively or also support wired communication. As such, the communication interface 214 may include a communication modem and/or other hardware/software for supporting communication via cable, DSL, universal serial bus (USB) or other mechanisms.

The user interface 212 may be in communication with the processor 210 to receive an indication of a user input at the user interface 212 and/or to provide an audible, visual, mechanical or other output to the user. As such, the user interface 212 may include, for example, a keyboard, a mouse, a joystick, a touch screen, a display, a microphone, a speaker, or other input/output mechanisms. In an example embodiment in which the apparatus 200 is embodied as a server or some other network devices, the user interface 212 may be limited, or eliminated.

In an example embodiment, the processor 210 may be in communication with or be embodied as, include or otherwise control a gaze tracker 218, a gaze modifier 220, a goal manager 222 and a visualization driver 224. The gaze tracker 218, the gaze modifier 220, the goal manager 222 and the visualization driver 224 may each be any means such as a device or circuitry embodied in hardware, software or a combination of hardware and software that is configured to perform the corresponding functions of the gaze tracker 218, the gaze modifier 220, the goal manager 222 and the visualization driver 224, respectively, as described below.

The gaze tracker 218 may be a device or module configured to determine and/or track the gaze of a user of the corresponding communication device. Thus, for example, the gaze tracker 218 may be configured to determine where the user is looking (e.g., where the user's gaze is focused) either instantaneously or over time. The gaze tracker 218 may use any suitable mechanism for gaze tracking including, but not limited to, eye tracking, head tracking, face detection, face tracking, mechanisms for determining lips, smile or other facial features, and/or the like. An output of the gaze tracker 218 may be gaze information indicative of a continuous or periodic record of the location of the user's gaze. The gaze tracker 218 may operate in real-time or substantially real-time (e.g., with little delay between determining the gaze information and communicating such information to another device or element) or may buffer or otherwise record the gaze information (e.g., using the memory device 216) for future use or processing. The gaze information could be a stream of data, a plurality of temporal and spatial segments of data, and/or an information file including data descriptive of the user's gaze.

In some situations, a camera or other device used for gaze tracking may also be utilized for gathering context related information or information descriptive of a workspace environment. As an example, a face detection and tracking algorithm may provide a measure of apparent interest and/or engagement of a particular participant in a communication session. Relative attractiveness of participants could also be determined. In other embodiments, a camera associated with the gaze tracker 218 may also provide video content of a workspace (e.g., the surroundings of a user of the apparatus 200), of one or more objects, and/or of a virtual environment. However, another camera or source for the video content may alternatively be provided.

In an example embodiment, the gaze information determined by the gaze tracker 218 may be provided to the gaze modifier 220 for modification and/or synthesis. The gaze modifier 220 may be configured to make modifications or transformations to the gaze information in order to provide an enhanced or synthesized output (e.g., modified gaze information) based on the gaze information provided. The modifications provided by the gaze modifier 220 may be made on the basis of goals or other criteria specified, for example, via the goal manager 222 as described in greater detail below. In various examples, the modifications may include generally, but are not limited to, smoothing of discontinuities in the gaze information, the provision of additional information appended to or inserted within the gaze information (e.g., markup information or metadata), the addition of another participants gaze information, the addition of generic gaze information (e.g., stored in a database), the addition of video or voice data from other participants, the inclusion of cursor and/or selection information, zoom information, the transformation or synthesis of gaze information based on provided goals, and/or the like.

In an example embodiment, some specific examples of modifications that the gaze modifier 220 may be configured to perform may include snapping the gaze to a particular object within a workspace (e.g., under certain trigger conditions that may be specified by the goal manager 222), using a moving average or other technique to smooth out gaze information over time, altering an uncertainty area of the gaze information based on various factors, repeating gaze information, removing or replacing gaze information, and/or the like. Other examples of modifications may include synthesis of the gaze information with other data and/or synthesis of gaze information of one or more participants in a CMC session. Thus, for example, instead of sharing segments of actual sensed gaze information or filling in for a lack of gaze information from one or more participants, the gaze modifier 220 may take data corresponding to gaze information from multiple sources (e.g., including current participants and/or generic gaze information) and merge the data together to provide composite gaze information. In some cases, generic gaze information could be combined with a speaker's gaze information delayed by a random window. In another embodiment, gaze information may be synthesized from cursor position and generic gaze information. Combinations of any or all of the above examples may also be performed.

In an example embodiment, the gaze modifier 220 may also be configured to provide an indication to a user of the apparatus 200 indicative of the modifications being provided (or to be provided) with respect to the user's first person gaze information and/or to modifications being provided (or to be provided) with respect to gaze information of another party. In certain circumstances (e.g., for security or privacy reasons), one or more parties may not be provided with such information or may not be enabled to perform one or more different types of modification. Accordingly, distributed computations and transformations may be enabled. As an example, a client device (e.g., one of the first and second communication devices 110 and 120) may have access to context and/or task information that is not made available to the service platform 140 and/or another device involved in communication with the client device due to security requirements associated with the client device. This may enable a device to indicate modifications that should be applied to some (potentially already modified) gaze information by other devices or servers.

As an example of additional information that may be provided to describe modifications, a segment of gaze information may be identified as co-occurring with some other event, a representation of which may or may not be available elsewhere. As another alternative, a segment may be associated with arbitrary information such as a spatial segment being associated with task-specific information designating the stage in a canonical or otherwise expected workflow corresponding to an area covered by the segment. As yet another example, a segment may be associated with other segments of gaze information. In this regard, semantic relationships that may be encoded include, for example, indicating that one segment is a modified version of another segment (and the converse) or indicating that two segments share a common origin (e.g., that they two segments are separate modifications of the same original gaze information).

In some embodiments, a listing of the modifications being applied to either incoming or outgoing gaze information may be provided at any of various levels of abstraction. For example, since some low level modifications may be switched between being on and off with some regularity based on context or other events or information, it may be useful to enable the provision of a relatively more stable list of modifications at a higher level of abstraction. In some cases, the user may (e.g., via the user interface 212) specify that certain modifications be enabled or disabled via a visualization of the listing of modifications (e.g., by an on/off toggle mechanism relative to the items listed).

The goal manager 222 may be configured to provide criteria such as goals, instructions, rules, preferences, and/or the like, with respect to modifications to be made by the gaze modifier 220. In some cases, the criteria may be provided by a user of the user of the apparatus 200 (e.g., via the user interface 212). However, the criteria may alternatively be provided by other parties (e.g., other participants in a CMC session), or may be predefined criteria. As such, in some situations, the goal manager 222 may serve as an interface between the user and the gaze modifier 220 with respect to directing modifications to be made to gaze information.

In an example embodiment, the goal manager 222 may store (e.g., via the memory device 216), access or apply criteria for gaze information modification including, for example, general goals, relationship-specific goals, task or role specific goals, user specified goals, information about shared or private workspaces, contextual and/or dynamic personal information, information used for a particular modification, and/or the like. In some cases, the goal manager 222 may develop goals based on information accessible to the goal manager 222 (e.g., relationship information, task based roles, past behavior, context information, etc.).

General goals may include criteria that apply universally to all communications. In some cases, general goals may only be applied when they do not conflict with other goals. However, the goal manager 222 may also include rules for de-conflicting the application of modification goals (e.g., on the basis of a hierarchy amongst the criteria). As an example, a general goal may include a preference for directing the listener's gaze to be co-located with the speaker's gaze at the end of an utterance if the listener's gaze dwelled in the same location for some time.

Relationship-specific goals may include preferences that are dependent upon the relationships of the participants (e.g., senior/subordinate, peer/peer, family, and/or the like). As such, for various different relationships between participants, corresponding different modifications may be made based on the goals corresponding to the relationship of the participants in each respective case. The relationship between the participants may be determined based on explicit social network information (e.g., from a social network service (SNS) or organizational database), information specified via a user entry defining the relationship between the participants, and/or statistical comparisons of behaviors attributable to participants during past and current interactions (some of which may be interactions with other individuals with known relationships).

Task or role specific goals may include preferences with respect to a particular type or class of task and/or the roles that specific participants have in a given task (which could be independent of the relationship between the participants). Task or role specific goals may be determined from information provided by an application or applications supporting a task. For example, structured descriptions of a current task and/or supporting tasks or information about an object in a shared workspace may be utilized for determining task or role specific goals. Task or role specific goals may also be determined and refined based on supervised or semi-supervised machine learning where known values of past outcomes (e.g., from questionnaires, post-task gaze and sensor data) may be used. In some cases, information provided by various applications may be used in learning supervision.

Specified goals may include specific rules provided by the user at various levels of abstraction. For example, a first user may specify a preference with respect to a relationship between the first user's gaze and the gaze of another user. Meanwhile, for example, a novice user may simply provide an adjective having corresponding specified rules for gaze modification based on the adjective. For example, designations such as “formal” or “informal” may include corresponding rules that direct the provided gaze information to be modified in a corresponding specific way. The rules may be specified by the user for each respective adjective, or the rules may be predefined for a set of pre-selected adjectives. In some instances, node-based and/or patch-based visual programming user interface may be employed to support the implementation of specified goal provision.

Information shared regarding shared and private workspaces may include goals that are “filled in” or instantiated by information about the workspace. As an example, such a goal may include a preference for snapping the gaze of one or more participants to the same object in the workspace under certain conditions and/or to snap participant gazes to an object to which the speaker's gaze otherwise snaps. Information about the shared workspace, including information about the general environment (e.g., via analysis of a windowing system) and/or information about applications running may be used to identify objects and the visual area consumed by the objects.

Contextual and/or dynamic personal information may include information about the current situation of one or more of the participants. Such information may also include information related to a participant's personal state or mood. Context and personal information may be gathered from sensors, activity records, time/date and other temporal criteria. In some situations context and/or personal information may also be gathered based on applications open and/or activity related to such applications. As an example of a modification that may be made on the basis of such information, if a particular user is determined to be drowsy, a mask may be applied (e.g., to an avatar or other likeness of the respective user) in order to indicate that the user is drowsy. Alternatively, a mask could be applied to indicate that the person is not drowsy if such a modification is desired. The processor 210 and/or the goal manager 222 may be configured to make context determinations in various example embodiments.

Upon receipt of any of the above described goals and/or other preference or goal related information for influencing modification of gaze information from the goal manager 222, the gaze modifier 220 may make corresponding modifications. As indicated above, the gaze modifier 220 may make modifications to gaze information for the user of the apparatus 200 or may provide additional information to the gaze information so that the additional information may be used by a instance of the gaze modifier either at the service platform 140 or at another apparatus (e.g., another communication device involved in a CMC session). The gaze modifier 220 may also extract additional information provided along with gaze information provided from the service platform 140 or another device and generate modifications based on the extracted additional information. A special markup or shared language may be used for defining modifications to be shared between devices in this manner. In this regard, the special markup or shared language may include, depend on or otherwise account for shared workspace or virtual environments.

The visualization driver 224 may be configured to drive a display device to display gaze information and/or modified gaze information in accordance with embodiments of the present invention. In some embodiments, the visualization driver 224 may not be included when the apparatus 200 is embodied at the service platform 140. However, when included at a respective device, the visualization driver 224 may provide for a display of gaze information as indicated from the gaze modifier 220. Thus, for example, the gaze modifier 220 may provide information indicative of the modified gaze information for display by the visualization driver 224 in which the information provided may be indicative of first person gaze information for the user of the apparatus 200 and/or gaze information for one or more other communication session participants. The visualization driver 224 may, in some cases, provide the gaze information (or modified gaze information) relative to video content showing a common workspace, object(s) or virtual environment. Thus, for example, the video content itself may be considered as modified video content. In some situations, modification of the video content may include modifying face orientation, eye orientation or the orientation of other features.

In some cases, the visualization driver 224 may provide for visualization of data provided from a gaze modifier 220 instantiated in another device. For example, raw gaze information (or modified gaze information) may be provided from the first communication device 110 to an instance of the gaze modifier 220 at the service platform 140. The gaze modifier 220 may make modifications to the raw gaze information and provide the modified gaze information to one or more instances of the visualization driver 224 at respective ones of the first communication device 110 and the second communication device 120. Alternatively, either or both of the first and second communication devices 110 and 120 may have instances of the gaze modifier 220 and/or the visualization driver 224 and modified gaze information may be exchanged therebetween with or without involvement from any service platform 140. Thus, visualization may be symmetrical or asymmetrical.

In an example embodiment, the users of different communication devices may be enabled to turn their gaze information and/or modifications thereto on or off. Thus, for example, a user may decide to suspend the sharing of gaze information and/or suspend the sharing of information regarding the modification of gaze information with other users. Moreover, since each user may be given control over gaze information modification at their own respective devices, one user's visualized gaze information may be different from another user's visualized gaze information even though both users have shared the same information with each other.

Some visualization methods may be more useful for gaze information modified or synthesized in particular ways. For example, a visualization in communication of gaze information aggregated over time may be considered to be appropriate to apply to gaze information that has been filtered for a gaze directed toward objects for which disclosing that they have been a significant object of gaze during the conversation is negative. For example, removing gaze information when it is directed at an advertisement not related to the task or an open window displaying a participant's personal email may be desirable for such a visualization that would make otherwise ignorable gaze salient. Visualization methods may also have explicitly specified relationships with corresponding synthesis and modification methods. For example, an indication may be provided for a particular visualization method as to whether the particular visualization method may be meaningfully applied to a particular modification or is a preferred mechanism for visualization for the particular modification. In some cases, the user (e.g., via the user interface 212) may be enabled to choose or assign relationships among various visualization methods.

Some example visualization methods that may be employed by the visualization driver 224 for modified (e.g., transformed, enhanced, and/or synthesized) gaze information may include visualizing gaze information aggregated for multiple participants over time (e.g., over a moving window of time), and visualizing gaze information in a non-explicit way (e.g., gaze information may be visualized as a zoom level on the workspace area around the cursor so that, for example, if two people gaze at the same object or area the visualization is zoomed in and if they look in different areas or at different objects the visualization is zoomed out). Another visualization method may include, visualizing real-time (or near real-time) gaze information for a participant as a highlighted area on a shared workspace. However, according to embodiments of the present invention, the gaze information may be modified gaze information as described above. A visualization of real-time gaze information may, rather than merely showing a single point, use a visualization (e.g., an indication of a location of the gaze of one or more users) over a larger visual area occupied by some object in the shared workspace (e.g., highlight the entire icon or table row indicated by the gaze information). This type of visualization may be considered appropriate for such modifications to gaze information as temporal smoothing, gaze area scale modification, and object snapping, as described above. In some instances, gaze information may be selectively and differentially visualized according to verbal and/or non-verbal communication of the participants. In this regard, for example, gaze information may be shown for only the currently speaking participant, for example, to focus attention on the speaker, especially in larger groups. Additionally, other participants' gaze may be shown with a different visualization. As an example, gaze information may be visualized as an aggregated gaze for all other participants. Alternatively, gaze information may be shown only when the speaker and several other participants gaze at the same object.

In an example embodiment, the visualization driver 224 may be configured to provide more than one visualization of the gaze information for a single person. In this regard, for example, multiple different visualization methods may be applied to the same information or the same (or different) visualization method may be applied to different versions of gaze information for the person. As an example, a first user's client device may visualize both: (1) the user's smoothed, but otherwise unmodified, gaze as a dot with a temporal “tail” and (2) a modified version of the user's gaze exactly as visualized on another user's client device.

The visualization driver 224 may also be configured to manifest gaze information in non-visual ways. In this regard, for example, the visualization driver 224 may be configured to manifest gaze information with sound. As such, gaze information may be used to modify the voices of participants, as heard by themselves and/or others. Spatialization of voices alone may provide a rich output. Beyond a basic association of voice position with position in a virtual environment, which may not apply to many shared workspaces, spatialization may be applied based on role. In some instances spatialization may be used for strategic benefit in negotiations.

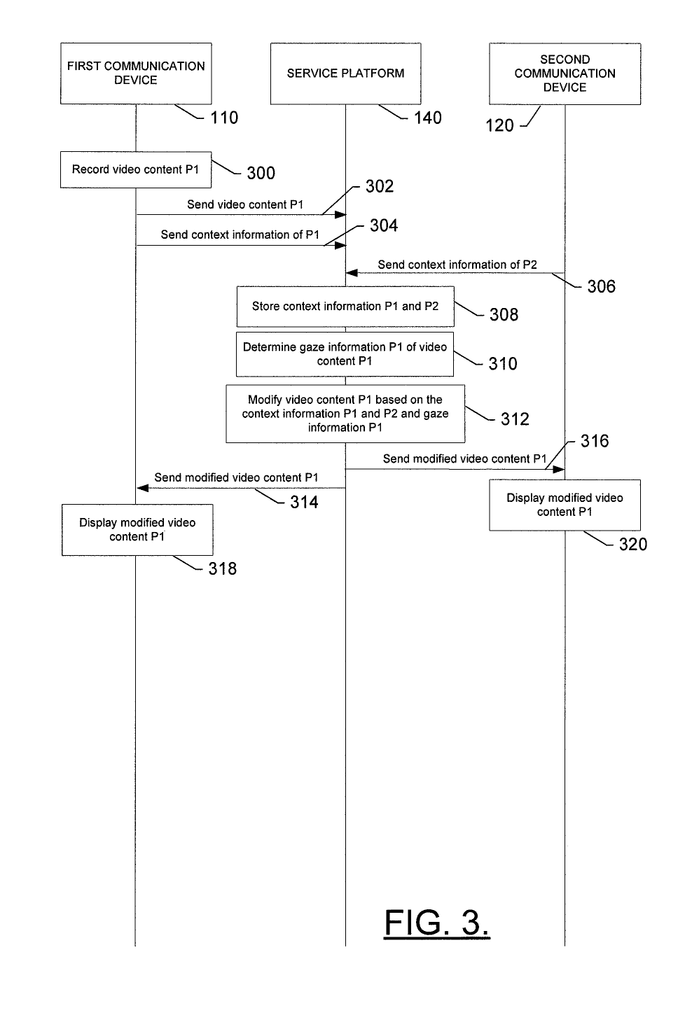

As indicated above, FIG. 1 shows an example system in which embodiments of the present invention may operate. However, the system of FIG. 1 is merely one example of such a system. Moreover, even within the context of the example system of FIG. 1, variations on the operation of the system may still be made while still within the scope of embodiments of the present invention. In this regard, for example, FIGS. 3-5 show example control flow diagrams illustrating signal flow and other actions of various entities from FIG. 1 in connection with different alternative embodiments. It should be noted that although each of the examples in FIGS. 3-5 shows only two participants, alternative embodiments may include more than two participants. Furthermore, although the examples of FIGS. 3-5 show content coming from only one participant, content could alternatively come from any of multiple participants in a communication session. However, the treatment of signaling from one such participant, as shown in FIGS. 3-5, provides an example that can be extrapolated to application for treatment of signaling from multiple participants. Additionally, although FIGS. 3-5 are illustrative of an example embodiment in which video content is modified, alternative embodiments could be practiced in the context of other content than video content. As such, for example, non-video (e.g., a word processing document) or pre-video content could alternatively be used. Moreover, the modifications performed may include adding information about how the content should be viewed (e.g., with respect to a portion modified or to be viewed). Thus, for example, devices with very different capabilities may be enabled to share information via embodiments of the present invention.

FIG. 3 illustrates a control flow diagram of a situation in which the service platform 140 may be employed for the modification of gaze information according to an example embodiment. In general terms, the embodiment of FIG. 3 illustrates a situation in which the service platform 140 receives video information from one participant (e.g., P1, which may be a user associated with the first communication device 110) and context information from two participants (e.g., P1 and P2, which may be a user associated with the second communication device 120). Gaze information for P1 may be determined from the video information and then the video information may be modified based on the context information of both users and the gaze information from P1. Each user may then receive the same modified video signal for display.

Specifically, P1 may record video content (e.g., using a camera or video recorder that may be a portion of an instance of the gaze tracker 218 embodied at the first communication device 110) at operation 300. The video content may then be communicated to the service platform 140 at operation 302. Context information may be gathered or determined at the first communication device 110 and also communicated to the service platform at operation 304. Context information may be gathered or determined also at the second communication device 120 for P2 and communicated to the service platform at operation 306. Although not necessary, the service platform may store (or buffer) the context information for P1 and P2 at operation 308. At operation 310, the service platform 140 may determine gaze information for P1 from the video content provided for P1. The determination of gaze information may be made, for example, by an instance of the gaze tracker 218 (or the processor 210) embodied at the service platform 140. The video content from P1 may then be modified based on the context information from P1 and P2 and/or based on the gaze information for P1 at operation 312. The modification may be performed by an instance of the gaze modifier 220, and may be made based on rules or criteria applied by an instance of the goal manager 222. At operations 314 and 316, the modified video content may be communicated to both the first and second communication devices 110 and 120, respectively. At operations 318 and 320, the modified video content may be displayed to both the first and second communication devices 110 and 120, respectively. The display of the modified video content may be accomplished via instances of the visualization driver 224 at each of the first and second communication devices 110 and 120.

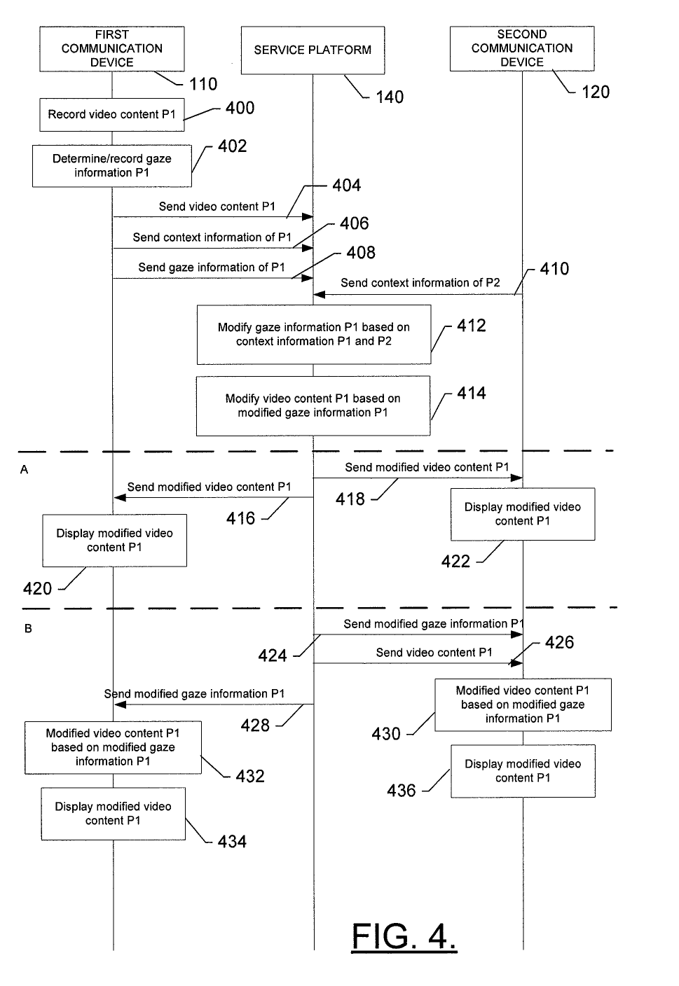

FIG. 4 illustrates a control flow diagram of alternative situations in which the service platform 140 may be employed for the modification of gaze information according to an example embodiment of the present invention. FIG. 4 illustrates an alternative mechanism for modifying video content relative to the example of FIG. 3, and also shows two separate examples (shown in regions A and B, respectively) of post-distribution treatment of video modified at the service platform.

In this regard, video for P1 may be recorded at operation 400. A determination may then be made at the first communication device 110 regarding gaze information for P1 (e.g., via an instance of the gaze tracker 218) at operation 402. The gaze information may be recorded or saved at the first communication device 110 as well. At operation 404, the first communication device 110 may communicate the video content for P1 to the service platform 140. Context information for P1 may also be determined and communicated at operation 406 and gaze information may be communicated at operation 408. Context information may also be provided for P2 from the second communication device 120 at operation 410. The service platform 140 may then modify the gaze information based on the context information from P1 and/or P2 at operation 412. The modified gaze information may then be used to modify the video content at operation 414.

Following modification of the gaze information and/or video content as described above, in one alternative distribution scenario shown by region A in FIG. 4, the modified video content may be distributed in similar fashion to that illustrated in FIG. 3. In this regard, at operations 416 and 418, the modified video content may be communicated to both the first and second communication devices 110 and 120, respectively and at operations 420 and 422, the modified video content may be displayed at both the first and second communication devices 110 and 120, respectively.

In another alternative distribution scenario shown in region B of FIG. 4, the modified gaze information for P1 may be provided to the second communication device 120 from the service platform 140 at operation 424 and the video content from P1 may be communicated to the second communication device at operation 426. The modified gaze information for P1 may also be communicated from the service platform 140 to the first communication device 110 at operation 428. At operation 430, the modified gaze information for P1 may be used to modify the modified video content for P1 by an instance of the gaze modifier 220 at the second communication device 120. Similarly, the modified gaze information for P1 may also be used to modify the modified video content for P1 by an instance of the gaze modifier 220 at the first communication device 110 at operation 432. In both cases, an instance of the goal manager 222 at each respective device may provide criteria based upon which the corresponding modifications are performed. At operations 434 and 436, the modified video content may be displayed at both the first and second communication devices 110 and 120, respectively.

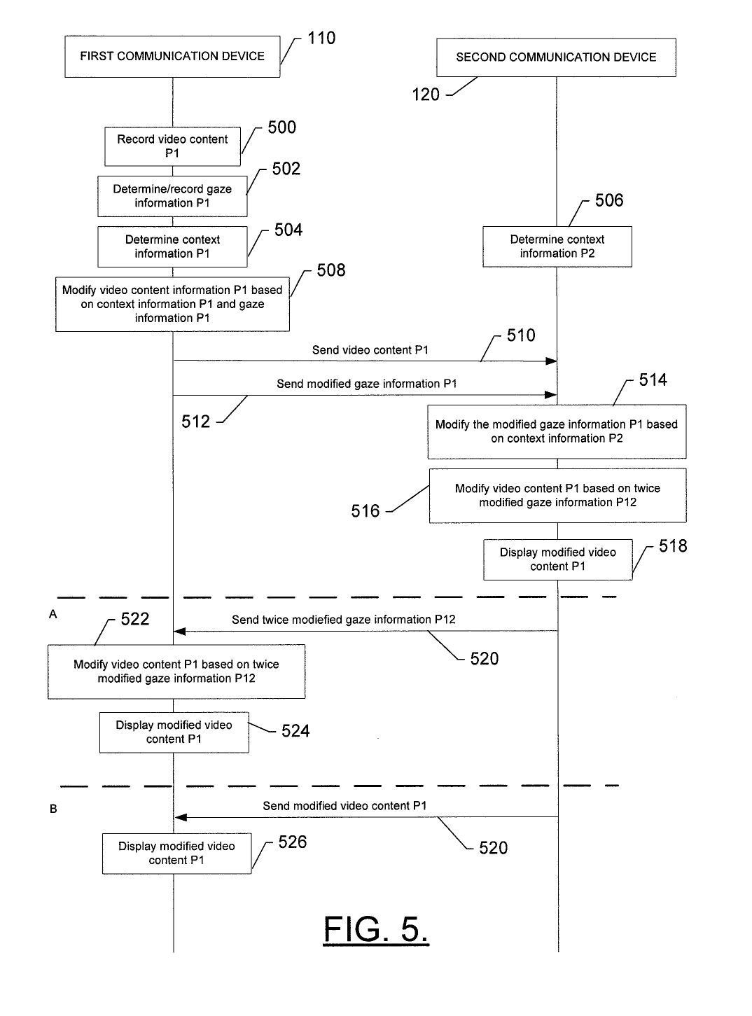

FIG. 5 illustrates a control flow diagram of a situation in which the modification of gaze information may be accomplished without assistance from a service platform according to an example embodiment of the present invention. In this regard, video for P1 may be recorded at operation 500. A determination may then be made at the first communication device 110 regarding gaze information for P1 (e.g., via an instance of the gaze tracker 218) at operation 502 and context information at operation 504. The gaze information may be recorded or saved at the first communication device 110 as well. Context information may separately be determined at the second communication device at operation 506. At operation 508, the first communication device 110 may modify the video content based on the context information and the gaze information. The modified video content may then be communicated to the second communication device at operation 510. At operation 512, the gaze information (which may have been modified based on the context of P1) may also be communicated to the second communication device 120.

At the second communication device 120, the gaze information for P1 may be modified based on context information for P2 at operation 514. At operation 516, the modified video content may then be further modified based on the gaze information modified from operation 514. The modified video content may then be displayed at the second communication device at operation 518.

In an example embodiment, the modified video content may then be communicated back to the first communication device at operation 520. In the example shown in region A, the first communication device 110 may further modify the video content based on the modified gaze information from operation 514 (e.g., applying the criteria set by its own instance of the goal manager 222) at operation 522 and then displaying the modified video content at operation 524. However, as an alternative, the modified video content from operation 520 may be displayed at the first communication device at operation 526 without further modification as shown in region B.

Embodiments of the present invention may provide for focus on the objects of discussion and may avoid any necessity for participants of resolving third-person gaze to the object-of-gaze. Embodiments may also increase empathy by fusing participants' fields of view. Embodiments may provide for a flexible division of labor for transmission, modification, and synthesis, which may enable effective employment with heterogeneous devices, networks, and trust relationships. Embodiments may also support tracking the provenance of non-original gaze information through a language for gaze modification and synthesis and support reference in modification and synthesis instructions to resources, objects, and areas in the shared workspace or environment.

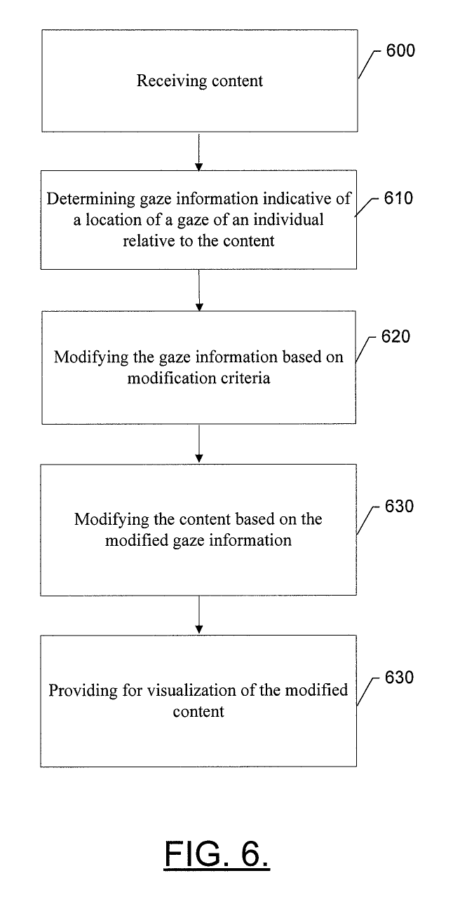

FIG. 6 is a flowchart of a system, method and program product according to example embodiments of the invention. It will be understood that each block or step of the flowchart, and combinations of blocks in the flowchart, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device and executed by a processor (e.g., the processor 210). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). Further, the functions specified in the flowchart block(s) or step(s) may be executed in any order. These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowcharts, may be implemented by special purpose hardware-based computer systems which perform the specified functions or steps, or combinations of special purpose hardware and computer instructions.

In this regard, one embodiment of a method for providing gaze information as provided in FIG. 6 may include receiving content at operation 600 and determining gaze information indicative of a location of a gaze of an individual relative to the content at operation 610. The method may further include modifying the gaze information based on modification criteria at operation 620 and modifying the content based on the modified gaze information at operation 630. At operation 640, the method may include providing for visualization of the modified content. As indicated above, the content could be video, non-video or pre-video content.

In an example embodiment, determining the gaze information may include utilizing analysis of a portion of the individual's face to determine the location of the gaze. Modifying the gaze information may include modifying the gaze information based on context information associated with the individual or a different individual. In some cases, modifying the gaze information may include modifying the gaze information based on modification criteria including a role of a participant in a communication session, a task assigned to the participant, an environment of the participant, an object in view of the participant, relationships between participants, general rules, participant specified rules, personal information associated with a participant, and/or the like. In an example embodiment, modifying the gaze information may include synthesizing gaze information associated with the determined gaze information and other gaze information or synthesizing gaze information associated with gaze information from multiple different individuals. In some situations modifying the gaze information may include applying a transformation to the gaze information in which instructions for the transformation are received as a portion of the gaze information.

In an example embodiment, modifying the content may include providing data for visual display indicating the modified gaze information relative to the content. In some situations, providing for visualization of the modified content may include delivering the modified content to a terminal associated with the individual or another individual.

In an example embodiment, an apparatus for performing the method above may include a processor (e.g., the processor 210) configured to perform each of the operations (600-640) described above. The processor may, for example, be configured to perform the operations by executing stored instructions or an algorithm for performing each of the operations. Alternatively, the apparatus may include means for performing each of the operations described above. In this regard, according to an example embodiment, examples of means for performing operations 600 to 640 may include, for example, the gaze tracker 218, the gaze modifier 220, the goal manager 222, the visualization driver 224, and/or the processor 210.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving content;
determining gaze information of an individual relative to the content;
modifying the gaze information based on modification criteria;
modifying the content based on the modified gaze information; and
providing for visualization of the modified content.

2. The method of claim 1, wherein determining gaze information is indicative of a location of a gaze of the individual relative to video content;

3. The method of claim 2, wherein determining the gaze information comprises utilizing analysis of a portion of the individual's face to determine the location of the gaze.

4. The method of claim 1, wherein modifying the gaze information comprises modifying the gaze information based on context information associated with the individual.

5. The method of claim 1, wherein modifying the gaze information comprises modifying the gaze information based on context information associated with a different individual.

6. The method of claim 1, wherein modifying the gaze information comprises modifying the gaze information based on modification criteria including:
a role of a participant in a communication session;
a task assigned to the participant;
an environment of the participant;
an object in view of the participant;
relationships between participants;
general rules;
participant specified rules; or
personal information associated with a participant.

7. The method of claim 1, wherein modifying the gaze information comprises synthesizing gaze information associated with the determined gaze information and other gaze information.

8. The method of claim 1, wherein modifying the gaze information comprises synthesizing gaze information associated with gaze information from multiple different individuals.

9. The method of claim 1, wherein modifying the gaze information comprises applying a transformation to the gaze information in which instructions for the transformation are received as a portion of the gaze information.

10. The method of claim 1, wherein modifying the content comprises providing data for visual display indicating the modified gaze information relative to the content.

11. The method of claim 1, wherein providing for visualization of the modified content comprises delivering the modified content to a terminal associated with the individual.

12. The method of claim 1, wherein providing for visualization of the modified content comprises delivering the modified content to a terminal associated with another individual.

13. A computer program product comprising at least one computer-readable storage medium having computer-executable program code portions stored therein, the computer-executable program code instructions comprising:
first program code instructions for receiving content;
second program code instructions for determining gaze information of an individual relative to the content;
third program code instructions for modifying the gaze information based on modification criteria;
fourth program code instructions for modifying the content based on the modified gaze information; and
fifth program code instructions for providing for visualization of the modified content.

14. The computer program product of claim 13, wherein the second program code instructions include instructions for utilizing analysis of a portion of the individual's face to determine a location of the gaze of the individual in order to determine the gaze information.

15. The computer program product of claim 13, wherein the third program code instructions include instructions for modifying the gaze information based on context information associated with the individual.

16. The computer program product of claim 13, wherein the third program code instructions include instructions for modifying the gaze information based on context information associated with a different individual.

17. The computer program product of claim 13, wherein the third program code instructions include instructions for modifying the gaze information based on modification criteria including:
a role of a participant in a communication session;
a task assigned to the participant;
an environment of the participant;
an object in view of the participant;
relationships between participants;
general rules;
participant specified rules; or
personal information associated with a participant.

18. The computer program product of claim 13, wherein the third program code instructions include instructions for synthesizing gaze information associated with the determined gaze information and other gaze information.

19. The computer program product of claim 13, wherein the third program code instructions include instructions for synthesizing gaze information associated with gaze information from multiple different individuals.

20. The computer program product of claim 13, wherein the third program code instructions include instructions for applying a transformation to the gaze information in which instructions for the transformation are received as a portion of the gaze information.

21. The computer program product of claim 13, wherein the fourth program code instructions include instructions for providing data for visual display indicating the modified gaze information relative to the content.

22. The computer program product of claim 13, wherein the fifth program code instructions include instructions for delivering the modified content to a terminal associated with the individual.

23. The computer program product of claim 13, wherein the fifth program code instructions include instructions for delivering the modified content to a terminal associated with another individual.

24. An apparatus comprising a processor configured to:
receive content;
determine gaze information of an individual relative to the content;
modify the gaze information based on modification criteria;
modify the content based on the modified gaze information; and
provide for visualization of the modified content.

25. The apparatus of claim 24, wherein the processor is configured to determine the gaze information by utilizing analysis of a portion of the individual's face to determine a location of the gaze of the individual in order to determine the gaze information.

26. The apparatus of claim 24, wherein the processor is configured to modify the gaze information by modifying the gaze information based on context information associated with the individual.

27. The apparatus of claim 24, wherein the processor is configured to modify the gaze information by modifying the gaze information based on context information associated with a different individual.

28. The apparatus of claim 24, wherein the processor is configured to modify the gaze information by modifying the gaze information based on modification criteria including:
a role of a participant in a communication session;
a task assigned to the participant;
an environment of the participant;
an object in view of the participant;
relationships between participants;
general rules;
participant specified rules; or
personal information associated with a participant.

29. The apparatus of claim 24, wherein the processor is configured to modify the gaze information by synthesizing gaze information associated with the determined gaze information and other gaze information.

30. The apparatus of claim 24, wherein the processor is configured to modify the gaze information by synthesizing gaze information associated with gaze information from multiple different individuals.

31. The apparatus of claim 24, wherein the processor is configured to modify the gaze information by applying a transformation to the gaze information in which instructions for the transformation are received as a portion of the gaze information.

32. The apparatus of claim 24, wherein the processor is configured to modify the content by providing data for visual display indicating the modified gaze information relative to the content.

33. The apparatus of claim 24, wherein the processor is configured to provide for visualization of the modified content by delivering the modified content to a terminal associated with the individual.

34. The apparatus of claim 24, wherein the processor is configured to provide for visualization of the modified content by delivering the modified content to a terminal associated with another individual.

35. An apparatus comprising:
means for receiving content;
means for determining gaze information of an individual relative to the content;
means for modifying the gaze information based on modification criteria;
means for modifying the content based on the modified gaze information; and
means for providing for visualization of the modified content.
